(19) United States
(12) Patent Application Publication
(10) Pub. No.: US 2024/0249459 A1
(43) Pub. Date: Jul. 25, 2024

(54) DATA-DRIVEN PHYSICS-BASED FACIAL ANIMATION RETARGETING

(71) Applicants: DISNEY ENTERPRISES, INC., Burbank, CA (US); ETH Zürich (Eidgenössische Technische Hochschule Zürich), Zürich (CH)

(72) Inventors: Derek Edward BRADLEY, Zürich (CH); Prashanth CHANDRAN, Zürich (CH); Eftychios Dimitrios SIFAKIS, Verona, WI (US); Barbara SOLENTHALER, Zürich (CH); Paulo Fabiano URNAU GOTARDO, Zürich (CH); Lingchen YANG, Zürich (CH); Gaspard ZOSS, Zürich (CH)

(21) Appl. No.: 18/421,429

(22) Filed: Jan. 24, 2024

Related U.S. Application Data
(60) Provisional application No. 63/481,573, filed on Jan. 25, 2023.

(51) Int. Cl. G06T 13/40

(52) U.S. Cl. CPC G06T 13/40

(57) ABSTRACT

One embodiment of the present invention sets forth a technique for retargeting a facial expression to a different facial identity. The technique includes generating, based on an input target facial identity, a facial identity code in an input identity latent space. The technique further includes converting a spatial input point from an input facial identity space of the input target facial identity to a canonical-space point in a canonical space. The technique still further includes generating one or more canonical simulator control values based on the facial identity code, an input source facial expression, and the canonical-space point. The technique still further includes generating a simulated active soft body based on one or more identity-specific control values, wherein each identity-specific control value corresponds to one or more of the canonical simulator control values and is in an output facial identity space associated with an output target facial identity.

### CROSS-REFERENCE TO RELATED APPLICATIONS

This application claims priority benefit of the United States Provisional Patent Application titled, “DATA-DRIVEN PHYSICS-BASED FACIAL ANIMATION RETARGETING,” filed on Jan. 25, 2023, and having Ser. No. 63/481,573. The subject matter of this related application is hereby incorporated herein by reference.

### BACKGROUND

### Field of the Various Embodiments

Embodiments of the present disclosure relate generally to computer science and computer-generated graphics and, more specifically, to data-driven physics-based facial animation retargeting.

### DESCRIPTION OF THE RELATED ART

Facial animation retargeting refers to the changing of the facial identity of a representation of a “target’ individual to produce a modified representation having an identity of a “source” individual while maintaining the performance of the target individual. The representation of each individual can be a mesh such as a geometric surface mesh or other 3D geometric representation stored in memory of a computer system. The geometric surface mesh can have triangular mesh elements, for example. Each mesh element can be specified by a number of vertices. For example, a triangular mesh element can be specified by three vertices, and a tetrahedral element can by four vertices, or a hexahedral element by eight vertices. The facial identity includes aspects of a facial appearance that arise from differences in personal identities, such as ages, eye colors, and/or other factors. For example, two different facial identities can be attributed to two different individuals, the same individual under different lighting conditions, or the same individual at different ages. The performance of an individual includes the identity of the individual and the facial expressions and poses of the individual encoded in the representation of the individual. The expression portion of a performance includes emotions and other non-identity aspects of the performance. The expression can include, for example, smiling, laughing, yelling, singing, and so on. The quality of the modified representation resulting from the facial animation retargeting is based on the persuasiveness with which the modified representation, e.g., as rendered on a display screen, appears to depict the source individual instead of the target individual while maintaining the performance of the target individual and/or the absence of visual artifacts that would reduce the persuasiveness.

Facial animation retargeting can be conducted in various types of scenarios. For example, the facial identity of an actor within a given scene of video content (e.g., a film, a show, etc.) could be changed to a different facial identity of the same actor at a younger age or at an older age. In another example, a first actor could be unavailable for a video shoot because of scheduling conflicts, because the first actor is deceased, or for other reasons. To incorporate the likeness of the first actor into video content generated during the shoot, footage of a second actor could be captured during the shoot, and facial animation retargeting could be used to replace the face of the second actor in the footage with the face of the first actor.

Various techniques for facial animation retargeting have been developed using computer animation. Animation techniques capture the performance of a source actor, generate an animation based on the performance, and retarget the animation to a desired target character. In computer animation, a model of an object being animated is constructed in memory and used to generate a sequence of images that depict movement of the object over a period of time. Soft body animation refers to computer animation of objects that have deformable surfaces, such as human faces. An active soft body can deform in response to contact with other objects, or as a result of contraction of muscles under the surface of the active soft body. A soft body model can be constructed to simplify the process of animating an active soft body. Once the model has been constructed, the active soft body's appearance can be controlled by specifying parameters for the model. For example, a soft body model can simulate the deformations of an active soft body caused by internal actuations, such as muscle contraction, or external stimuli such as contacts and external forces.

Another approach to facial animation retargeting produces retargeted animations using a two-step method that first transfers local expression details to the target and then performs a global face surface prediction that applies anatomical constraints to a shape space of the target character. This approach also combines local blendshape weight transfer with identity-specific skin thickness and skin sliding constraints on a given target bone geometry. A blendshape is a model of a facial expression expressed as a weighted average of a number of other facial expressions. The weight of each individual facial expression specifies the amount of influence the individual facial expression has on the overall blendshape model. However, this approach does not consider physical effects such as lip contact, collision with internal teeth and bone structures, or other physical effects that allow artist control over the retargeted performance.

As the foregoing illustrates, what is needed in the art are more effective and efficient techniques for changing facial identifies in video frames and images.

### SUMMARY OF THE INVENTION

One embodiment of the present invention sets forth a technique for retargeting a facial expression to a different facial identity. The technique includes generating, based on an input source facial expression, a facial expression code in an expression latent space. The technique further includes generating, based on an input target facial identity, a facial identity code in an input identity latent space. The technique further includes converting a spatial input point from an input facial identity space of the input target facial identity to a canonical-space point. The technique further includes generating one or more canonical simulator control values based on the facial expression code, the facial identity code, and the canonical-space point. The technique further includes generating a simulated soft body based on one or more identity-specific control values, each of which corresponds one or more of the canonical simulator control values.

One technical advantage of the disclosed techniques relative to the prior art is that training the actuation network on multiple characters in the canonical space reduces the amount of training data needed for each character. Another technical advantage of the disclosed techniques is that coordinated data is not needed across characters. The training performances can be different from character to character, but, since the actuation network is trained on multiple characters in a single shared canonical space, the network can learn character-specific activations across the training dataset. Training the actuation network on multiple characters enables the actuation network to interpolate across the identity-expression space and generalize to target identities that were not seen during training and also to source expressions that were not seen during training.

Another technical advantage of the disclosed techniques is that the resulting retargeted animation is collision-free, and the actuation network need not learn to handle collisions. Existing techniques implement collision handling in the training of a neural network, which causes the network to predict actuations that model collisions in addition to other effects not related to collision, which can complicate the model and detract from the learning of the other effects. In the disclosed technique, collision handling is performed using a contact model in a simulator that generates the retargeted result animation based on the predicted actuations, so the actuation network learns muscle-driven expression activations but does not learn collisions. Thus, in the disclosed technique, the actuation model does not attempt to model collisions in addition to the mapping of the latent code to actuations, so the actuation model can focus on learning to predict actuations. Still another technical advantage of the disclosed techniques is that the implicit function technique enables the neural network to be substantially smaller in size relative to neural networks used in existing techniques, while reliably reproducing fine details such as wrinkles. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of various embodiments.

FIG. 2A is a more detailed illustration of the mapping networks training engine of FIG. 1, according to various embodiments.

FIG. 2B is a more detailed illustration of the control networks training engine of FIG. 1, according to various embodiments.

FIG. 3 is a more detailed illustration of the execution engine of FIG. 1, according to various embodiments.

FIG. 4 is a flow diagram of method steps for training one or more machine learning models to perform facial animation retargeting, according to various embodiments.

FIG. 5 is a flow diagram of method steps for facial animation retargeting, according to various embodiments.

FIG. 6 illustrates neural networks that perform facial animation retargeting, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

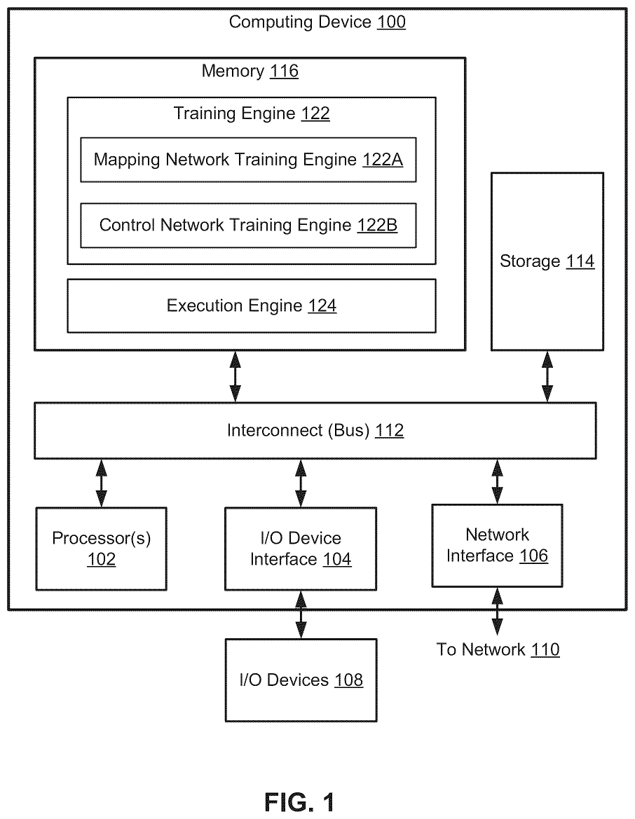

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and an execution engine 124 that reside in a memory 116. Computing device 100, training engine 122, and execution engine 124 can be included in a facial animation performance retargeting system.

It is noted that the computing device described herein is illustrative and that any other technically feasible configurations fall within the scope of the present disclosure. For example, multiple instances of training engine 122 and execution engine 124 could execute on a set of nodes in a distributed and/or cloud computing system to implement the functionality of computing device 100. In another example, training engine 122 and/or execution engine 124 could execute on various sets of hardware, types of devices, or environments to adapt training engine 122 and/or execution engine 124 to different use cases or applications. In a third example, training engine 122 and execution engine could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Training engine 122 and execution engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 and execution engine 124.

In some embodiments, a facial animation performance retargeting system includes a training engine 122 trains one or more machine learning models to perform facial animation retargeting. Facial animation retargeting involves extracting the expression portion of a performance of a character and transferring the expression to another character having a different identity. For example, a performance in which a source character named Amy is smiling can be transferred to a character named Bob using one or more machine learning models. The Bob character is represented as a 3D active soft body, for example. The machine learning model(s) generate muscle actuation values (“actuations”) that control a physics-based simulator. The actuations represent muscle contractions and cause the simulator to deform an active soft body object into a shape that represents the retargeting result. Each actuation can be specified as a symmetric 3×3 actuation matrix, for example. The simulator generates a simulated active soft body model of Bob, and the simulated active soft body model of Bob has a facial expression that is semantically equivalent to Amy's facial expression. For example, the simulated active soft body model of Bob impersonates the smiling expression from Amy, e.g., by moving Bob's facial muscles in a way that causes Bob to smile in a way similar to Amy's smile.

The facial retargeting operation thus transfers the performance of a given “source identity” (or at least a source expression) to a given “target identity” to cause the target identity to impersonate the expression of the source identity. The result, in which the simulated active soft body of the target identity impersonates the expression of the source identity, is referred to herein as a “retargeting result.” The simulated active soft body of the target identity has a facial expression that is semantically equivalent to the input source facial expression.

The training engine 122 includes a mapping network training engine 122A and a control network training engine 122B. The control network training engine 122B creates a data-driven model of a physical face for use in facial animation retargeting by training an actuation network, which can generate actuations for a physics-based simulator based on an input source facial expression and an input target facial identity. The simulator generates a simulation of a retargeted facial animation based on the actuations. The actuation network is trained on performance data for multiple identities, thereby reducing the amount of data needed per identity, and learning cross-identity physical correlations. The term “material space” herein refers to a space associated with a particular identity, such as the space of performance data for a particular identity. Different identities are in different material spaces and have different material extents that do not spatially or semantically correspond to each other. As such, combining different identities during training can result in meaningless actuations being generated by the actuation network. Accordingly, the mapping network training engine 122A trains one or more mapping networks, each of which maps a respective captured character from an identity-specific material space (e.g., a coordinate space) to an identity-independent canonical space (e.g., another coordinate space). The canonical space is a shared space that can include multiple characters. The characters in the canonical space can be used as input to the control network training engine 122B that trains an actuation network to generate actuations for a physics-based simulator. The actuation network is trained using training data that includes captured characters. For each captured character in a training data set, the actuation network training engine 122B trains the actuation network to minimize an amount of loss between the captured character and an active soft body generated by a simulator from actuation control values generated by the actuation network for the captured character.

The control network training engine 122B trains the actuation network to generate actuation values for facial muscles based on the canonical-space points that represent the captured character and further based on a facial expression and a facial identity of the captured character. The control network training engine 122B can also train another control network, referred to herein as a bone network, to generate bone positions for a jaw based on the facial expression and facial identity of the captured character. The actuations and/or bone positions output by the control networks are mapped back to an identity-specific space of a particular identity and provided to the simulator as input. The simulator generates a simulated active soft body that represents the muscle actuations of the facial identity of the captured character performing the facial expression of the captured character as applied to the face of the captured character.

The control networks are trained based on an amount of loss determined between the captured character and the simulated active soft body. The control network training engine 122B repeats the training operations for additional captured characters from the training input until completion condition is satisfied. Training the actuation network and/or the bone network on the performance data of multiple captured characters (each of which has a different identity) reduces the amount of training data needed per identity, and enables the actuation network and/or the bone network to learn cross-identity physical correlations that can be used in performance retargeting.

The facial animation performance retargeting system also includes an execution engine 124 that performs performance retargeting using the trained mapping networks and control networks. The execution engine 124 receives a source facial expression and a target facial identity for expression transfer. The execution engine 124 maps points from an identity-specific material space (e.g., a soft tissue space of a face associated with the target facial identity) to a canonical space, and provides the canonical space points, the source facial expression, and the target facial identity to the trained actuation network. The execution engine 124 can additionally or alternatively provide the source facial expression, and the target facial identity to the trained bone network. The actuation network generates actuation values in canonical space, and the bone network generates bone position values in canonical space. The execution engine 124 provides the source facial expression, the target facial identity, and the canonical space points to the actuation network, which generates actuation values in canonical space. The execution engine 124 can also provide the source facial expression and target facial identity to the bone network, which generates bone position values in canonical space. The execution engine 124 maps the actuation values and the bone position values to an identity-specific space of a particular identity using an inverse of the mapping provide by the mapping network for the particular identity.

The particular identity can be the same as the target facial identity, or can be a different identity for which a trained mapping network exists. The execution engine 124 provides the identity-specific actuation values and bone position values to the simulator as input. The simulator then generates an animated active soft body that represents the muscle actuations of the target facial identity performing the source expression as applied to the face of the particular identity. The training engine 122 uses real-world performance data, which can include identity-specific collision responses resulting from surface penetrations that are often present in real-world performance data. Even if surface penetrations are not present, the performance data can have collision responses such as bulging of lips when they press. The bulge is identity-specific, so the control networks need not learn actuations for simulation of the bulge. Accordingly, the control networks use a differentiable collision model, in which the control networks learn collision-agnostic muscle actuation mechanisms. The control networks thus do not learn collisions effects, such as skin deformations, as part of the actuation mechanism. The control networks retarget the learned collision-agnostic actuation mechanisms to different identities at inference time. The execution engine 124 applies identity-specific collision response during simulation, which occurs subsequent to performance retargeting performed by the control networks.

Although the mapping network training engine 122A and the control network training engine 122B are shown and described in the examples herein as separate components of the training engine 122 that are trained separately, the mapping network training engine 122A and the control network training engine 122B can be implemented in any number of components, e.g., as one component, and trained in any suitable manner, e.g., in an end-to-end training process in which the mapping network and control network are trained together.

### Data-Driven Physics-Based Facial Animation Retargeting

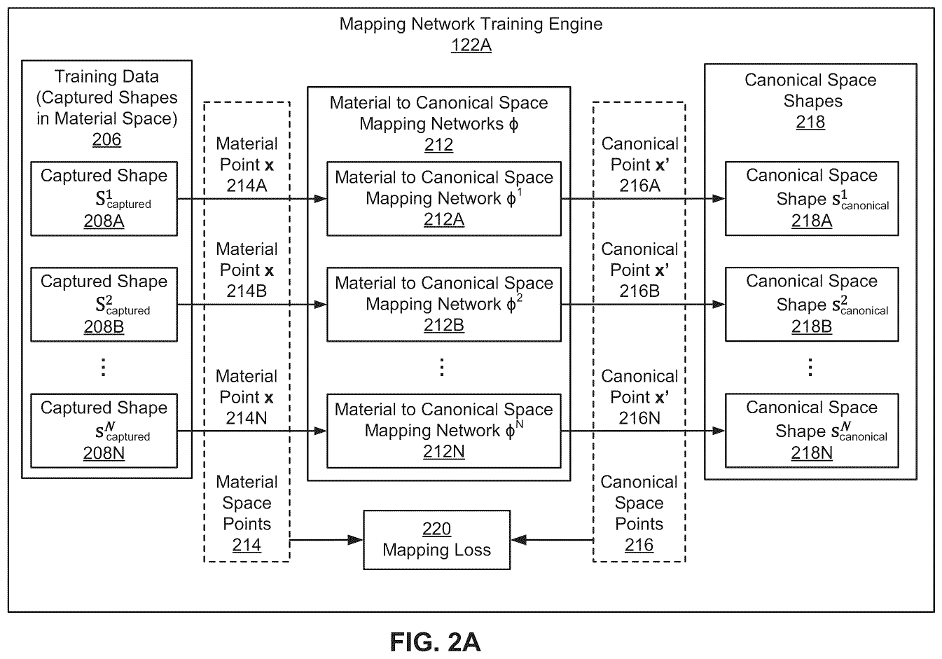

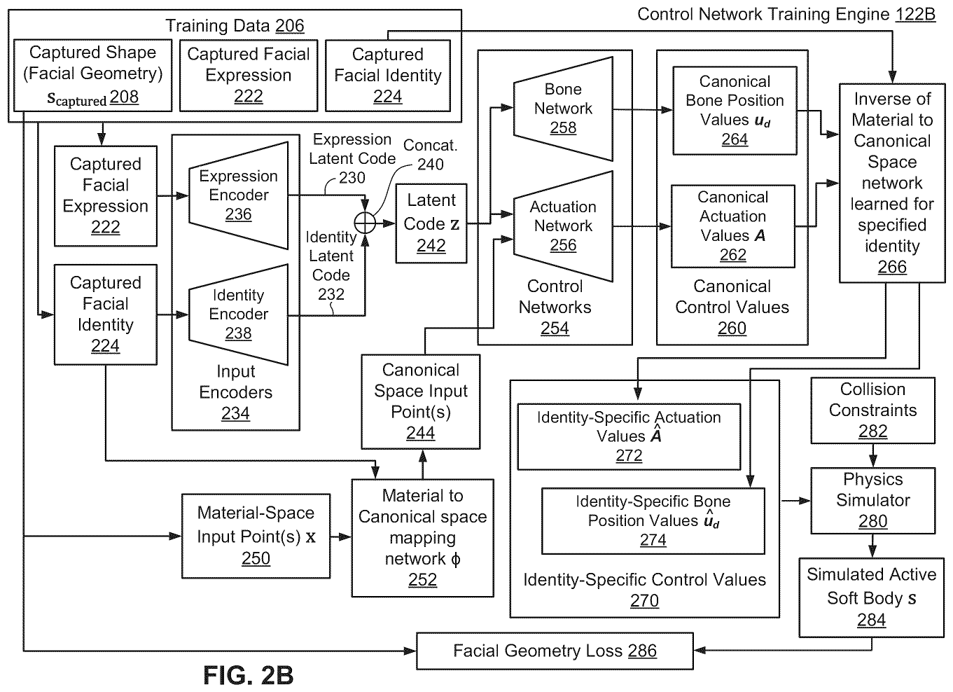

FIG. 2A is a more detailed illustration of the mapping networks training engine 122A of FIG. 1, according to various embodiments. More specifically, FIG. 2A illustrates the operation of training engine 122A in training one or more material to canonical space mapping networks 212 based on training data 206. The training data 206 includes 3D facial animation sequences of a set of identities performing different performances, such as dialogs and/or random facial expressions. A number of the identities (e.g., two-thirds of the identities in the training data 206) are used for training, and the remaining (e.g., one-third of the identities in the training data 206) can be reserved for use by the execution engine 124 to retarget to/from unseen identities at inference time. The training data 206 for each identity can include, e.g., 30 seconds (or other suitable length) of captured data per identity. Further, a number of static facial expressions (e.g., 20 expressions) are captured for each identity. The static facial expressions are semantically consistent across identities and are used to determine a blendshape basis. The basis is used to optimize for per-frame blendweight vectors for the performance data. The captured data includes one or more 3D geometric surface meshes. The 3D geometric surface meshes can include a skull surface mesh for each identity and/or a mandible surface mesh for each identity. A mandible surface mesh can be tracked for each expression using the technique described in U.S. patent application Ser. No. 18/159,651, filed Jan. 25, 2023, which is incorporated herein by reference. A simulation mesh is generated for each identity by discretizing the space of the captured skull surface mesh and/or mandible surface mesh with the help of an artist. Further, a mapping is computed between the simulation mesh and the captured geometric surface mesh and/or bones. The mapping is used to embed the captured geometric surface mesh in the simulation mesh. Different identities have different material extents, so the resulting simulation meshes are not necessarily in correspondence across identities, even if the captured surface meshes are. The simulation mesh with embedded surface and/or bone geometry for each identity is referred to herein as an identity-specific “material space.”

The result of processing the training data 206 for each identity is shown as a captured shape 208. Each captured shape 208A, 208B, 208N includes and/or references a sequence of facial geometric surface meshes with bone geometry in topological correspondence, corresponding blendshape weights, and the identity-specific simulation mesh of hexahedral elements with facial geometry and bone attachments embedded (e.g., using trilinear interpolation for the hexahedral elements). Each captured shape 208A, 208B, 208N corresponds to a respective identity. Each identity-specific material space can represent a 3D space within a face. The face can have an outer surface specified as a captured shape 208. The captured shapes 208 have different identity-specific material spaces, which include different geometric surface meshes with different numbers and layouts of volumetric elements. Because of these differences, different captured shapes 208 in their material spaces are not suitable for training the same actuation network. Thus, the mapping network training engine 122A trains a set of mapping networks 212 to map material points 214 from identity-specific material spaces, to respective canonical space points 216 in a shared identity-independent canonical space.

In various embodiments, each mapping network 212A, 212B, 212N is associated with a particular identity and is trained to map material points 214 that are in an identity-specific material space to respective canonical points 216 that are in the canonical space. Since each captured shape 208 represents a different captured character, each captured shape 208 has a respective individual identity, and each material to canonical space mapping network 212 is specific to the respective individual identity. The mapping network training engine 122A trains the one or more material to canonical space mapping networks 212 based on a mapping loss 220, which is determined between each material point 214 and each corresponding canonical point 216. For example, the training data 206 includes a captured shape S1 208A for a particular identity, and a material to canonical space mapping network 212A is trained to minimize a mapping loss 220 between each material point 214A in a set of material points 214 and a respective canonical point 216A in the canonical space. The canonical points 216A form a canonical space shape S1 218A. As another example, the training data 206 includes a captured shape S2 208B for another identity, and a material to canonical space mapping network 212B is trained to minimize a mapping loss 220 between each material point 214B in a set of material points 214 and a respective canonical point 216B in the canonical space. The canonical points 216B form a canonical space shape S2 218B. As still another example, the training data 206 includes a captured shape SN 208N for still another identity, and a material to canonical space mapping network 212N is trained to minimize a mapping loss 220 between each material point 214B in a set of material points 214 and a respective canonical point 216B in the canonical space. The canonical points 216B form a canonical space shape SN 218N. Each material to canonical space mapping network 212 can be a multi-layer perceptron (MLP) neural network, for example. The MLP neural network is trained to represent the mapping (e.g., deformation) x′=ϕ^{id}(x), where x 214 is in the identity-specific material space of identity id and x′ 216 is in the canonical space. During training, the mapping is supervised on the surfaces of the 3D surface meshes for the respective identities. The mapping loss 220 is determined for a particular identity id as follows:

$${ℒ}_{m a p}^{i d} = \frac{1}{\vert {T}_{C} \vert} ‖ {ϕ}^{i d} ( {T}_{M} ) - {T}_{C} ‖ .$$

T_{M} represents a list of 3D points in an identity-specific space and T_{C} represents a list of corresponding points in the canonical space. The points T_{M} are arbitrary points in the identity-specific space. The function ϕ^{id} represents the material to canonical space mapping networks 212 and maps the identity-specific points to the corresponding points on the canonical surface. The mapping loss is based on the difference between the identity-specific points and the corresponding points on the canonical surface. A regularization term (not shown) can be added to the mapping loss to smooth the volumetric mapping.

The canonical space is a shared space that can include multiple canonical space shapes that correspond, respectively, to multiple captured shapes 208. The canonical space shapes can be used as input to the control network training engine 122B. Training an actuation network 256 in canonical space ensures that actuation values 262 produced by the actuation network 256 are semantically meaningful across the identities on which the actuation network 256 is trained. Because the actuation network 256 is trained in the canonical space, the actuation network 256 is agnostic to the number and layout of actuation elements and can be trained on different facial identities from different material spaces at the same time (e.g., in the same execution of a training process). The canonical actuation values 262 for a particular canonical space input point 244 are also referred to herein as an actuation matrix A. A is, for example, a symmetric 3×3 actuation matrix, whose eigenvectors indicate the muscle contraction directions and eigenvalues indicate the magnitudes of the local deformation of a mesh element. Since the actuation network 256 is trained on N points, the actuation network 256 generates N actuation matrices (corresponding to N sets of canonical actuation values 262). The set of N actuation matrices is referred to herein as an actuation tensor field [symbol] , and the actuation matrix for a canonical space input point 244 (x) having an index i is Aᵢ. The actuation network 256 is trained to learn a canonical-space actuation tensor field that is agnostic to the geometry of each captured shape 208 (e.g., each subject's face). The physics simulator 280 operates in identity-specific space and receives as input an identity-specific actuation tensor field, however. An inverse of a material to canonical space mapping network 252 can be used to map the canonical control values 260 back to an identity-specific space. The material to canonical space mapping network 252 can be represented as φ: xϵ [symbol] _{M}→Xϵ [symbol] _{C} and the inverse mapping can be represented as φ⁻¹: xϵ [symbol] _{C}→Xϵ [symbol] _{M}. The inverse mapping from the canonical actuation values 262 to identity-specific actuation values 272 changes the actuation tensor produced by the actuation network 256, which can be decomposed into contractile directions and magnitudes. Instead of directly mapping to material space using the canonical-space actuation function and the mapping φ (e.g., using [symbol] (φ(x))), [symbol] (φ(x)) is used with the Jacobian of φ⁻¹. The Jacobian of φ⁻¹ is:

$$\frac{\partial {ϕ}^{- 1} ( X )}{\partial X} .$$

The magnitudes should not change along with the Jacobian, as otherwise there will be extra deformation induced for the rest shape of the target mesh. Further, the contractile directions should correlate with the Jacobian, e.g., to rotate consistently, thereby preserving semantic meaning. The learned canonical contractile direction is expected to be the same (e.g., aligned) for each subject in the learned canonical space. To achieve these goals, the rotational component R₁₀₀_{^{−1}} of the Jacobian could be factored out to produce the following material-space actuation tensor:

$$( x ) = {R}_{{ϕ}^{- 1}} ( ϕ ( x ) ) {R}_{{ϕ}^{- 1}}^{T} .$$

However, two separate networks need not be trained for φ and φ⁻¹ because of the implicit relation

$$\frac{\partial {ϕ}^{- 1} ( X )}{\partial X} = \frac{\partial {ϕ ( x )}^{- 1}}{\partial x}$$

which implies that R_{ϕ}_{^{−1}}=R_{ϕ}⁻¹=R_{ϕ}^{T}. It follows that the identity-specific actuation function in an identity-specific space for an identity having mapping function ϕ(x) is

$$( x ) = {{R}_{ϕ} ( x )}^{T} ( ϕ ( x ) ) {R}_{ϕ} ( x ) ,$$

where R_{ϕ} is the rotational component of the Jacobian of ϕ at point x, [symbol] (x) is the canonical-space actuation function, and [symbol] (x) is the identity-specific actuation function in an identity-specific space for a particular identity. Accordingly, the canonical actuation values 262 for a given material space input point 250 “x” can be converted to the identity-specific actuation values 272 by multiplying R_{ϕ}(x)^{T} (the transpose of the matrix R_{ϕ}(x)) by the canonical actuation values 262 and multiplying the result by R_{ϕ}(x). Learning the canonical-space actuation tensor field in this way is based on the observation that the learned canonical contractile direction is expected to be the same (e.g., aligned) for all subjects in the learned canonical space.

FIG. 2B is a more detailed illustration of the control networks training engine 122B of FIG. 1, according to various embodiments. More specifically, FIG. 2B illustrates the operation of a control network training engine 122B in training one or more control networks 254 based on training data 206 that includes data for a set of captured characters. For each captured character, the training data 206 includes a captured shape 208, a captured facial expression 222, and a captured facial identity 224. For example, the captured facial identity 224 can be a captured surface mesh of a target identity, or can be associated with a captured surface mesh of a target identity. The captured shape 208 can be, for example, a surface model generated from a sequence of poses depicted in a sequence of scanned images. The captured shape 208 includes a 3D surface geometry of a face, also referred to herein as a “facial geometry.” The captured facial expression 222 can be, e.g., an expression blend weight vector for a blendshape model. The captured facial identity 224 can be, e.g., a numeric value identifying a particular facial identity associated with the captured shape 208. The captured facial identity 224 can be a vector of length 4 dimensions, which is optimized for during training, for example.

The control network training engine 122B selects a captured character from the training data 206 and identifies a material space input point 250 in the material space of the captured shape 208. Each material space input point 250 can be in the captured shape 208. The space inside the face represented by the captured shape 208 can be a three-dimensional space specific to a particular identity and is also referred to herein as an identity-specific “soft tissue space.” The material space input points 250 can be arbitrarily chosen points in the identity-specific soft tissue space. A material to canonical space mapping network 252 maps each material space input point 250 to a corresponding canonical space input point 244.

The control network training engine 122B trains the control networks 254 in a canonical 3D space. Accordingly, each material space input point 250 is converted to the canonical space input point 244 using a material to canonical space mapping network 252. The canonical space input point 244, which is in the canonical 3D space, is provided as input to one or more control networks 254, which generate canonical control values 260 based on the captured facial expression 222 of the character and the captured facial identity 224 of the character. Each canonical control value 260 can specify an actuation of a canonical geometric surface mesh in the canonical space. The control network training engine 122B then converts the canonical control values 260 to identity-specific control values 270 in an identity-specific space of the captured facial identity 224. The identity-specific control values 270 are provided as input to a physics simulator 280, which performs a soft-body simulation and generates a simulated active soft body (“soft body”) 284 that conforms to one or more collision constraints 282. The soft body 284 represents a face of a character having the muscle actuations of the captured facial identity 224. The muscle actuations of the captured facial identity 224 cause deformations in a simulation mesh used by the physics simulator 280. The simulation mesh is further described herein with respect to FIG. 2A. The physics simulator 280 generates a soft body 284 having a shape based on the deformed simulation mesh. The soft body 284 represents a character performing the expression specified by the captured facial expression 222 as applied to the face of the captured facial identity 224.

In various embodiments, the mapping network training engine 122A converts points on the captured shape 208 to canonical space input points 244 using a material to canonical space mapping network 252 that corresponds to the captured facial identity 224 of a captured shape 208 in the training data 206. The material to canonical space mapping network 252 is trained as described herein with reference to FIG. 2A. The mapping network training engine 122A provides each canonical space input point 244 to the control network(s) 254. The control network(s) 254 generate the canonical control values 260.

The mapping network training engine 122A uses an inverse mapper 266 to convert the canonical control values 260 to the identity-specific control values 270 that are provided as input to the physics simulator 280. The inverse mapping 266 can use the identity-specific actuation function [symbol] (x)=R_{ϕ}(x)^{T} [symbol] (ϕ(x))R_{ϕ}(x) described herein with respect to FIG. 2A. The actuation function [symbol] (x) maps the material to canonical space mapping network 252 to the identity-specific actuation values 272. The physics simulator 280 that generates the soft body 284 can be a differentiable physics solver that enables the use of gradient-based methods for solving complex control problems. The identity-specific control values 270 can include one or more identity-specific actuation values 272. The physics simulator 280 deforms the shape of the soft body 284 in accordance with an internal actuation mechanism that is configured based on the actuation values 272. The amount of stretching or contraction of each mesh element of a simulation mesh can be specified by the actuation values 272. The internal actuation mechanism determines the shape of the resulting deformed simulation mesh in accordance with the identity-specific actuation values 272 as constrained by laws of physics implemented by the physics simulator 280. The shape of the simulated active soft body 284 is based on the deformed simulation mesh.

The physics simulator 280 can also receive a bone position as input. The bone position can represent the position of a jaw bone relative to a face represented by the soft body 284, for example. A bone position input to the physics simulator 280 that moves the jaw bone associated with the soft body 284 downward can cause the mouth portion of the face to open, for example. The bone position can be specified by the identity-specific bone position values 274.

In various embodiments, the soft body 284 is represented as a simulation mesh that includes a set of mesh elements, which can be a hexahedra or tetrahedra, for example. The simulation mesh can include a set of mesh vertices that determine the shape of the soft body 284. The actuation mechanism induces a simulated force that causes motion of the discrete mesh elements. The physics simulator 280 deforms the shape of the soft body 284 by changing the spatial locations of the vertices of the mesh elements in accordance with the internal actuation mechanism. The soft body 284 can deform in response to contact with other objects, or as a result of stretching or contraction of hexahedral mesh elements, for example.

The identity-specific actuation values 272, which are generated by the inverse mapping 266 from the canonical actuation values 262, specify deformations of particular mesh elements, e.g., as amounts by which particular mesh elements are to stretch or contract. The identity-specific bone position values 274, which are generated by the inverse mapping 266 from the canonical bone position values 264, can be an identity-specific transformation matrix, which is in an identity-specific space. The identity-specific transformation matrix can be applied, e.g., by the physics simulator 280, to points on the bone geometry to transform the jaw bone position as specified by the latent code 242 provided as input to the bone network 258. The actuated simulation mesh is generated by deforming an initial mesh (not shown) in accordance with the identity-specific actuation values 272. The initial mesh can be associated with the captured shape 208. The initial mesh can be a voxelized mesh that includes a set of hexahedra, tetrahedra, or other suitable polygons, and/or a set of vertices, for example.

The control networks 254 include an actuation network 256, which generates canonical control values 260 for a simulation of a face, and/or a bone network 258, which generates canonical control values 260 for simulation of a jaw bone that moves relative to the face. The canonical control values 260 include canonical actuation values 262 and canonical bone position values 264, which are generated by the actuation network 256 and the bone network 258, respectively. The control networks 254 are trained to minimize an amount of loss, which includes a facial geometry loss 286 determined based upon a geometric difference between the soft body 284 and the captured shape 208. The control networks 254 can be neural networks or other machine learning models, for example. For example, the actuation network 256, the bone network 258, and/or each material to canonical space mapping network 252 could include, but are not limited to, one or more convolutional neural networks, fully connected neural networks, recurrent neural networks, residual neural networks, transformer neural networks, autoencoders, variational autoencoders, generative adversarial networks, autoregressive models, bidirectional attention models, mixture models, diffusion models, neural radiance field models, and/or other types of machine learning models that can process and/or generate content.

The actuation network 256 receives as input a latent code 242 in a latent space and a canonical space input point 244. The latent code 242 is generated by a concatenation operator 240, which concatenates an expression latent code 230 with an identity latent code 232. The expression latent code 230 is generated by an expression encoder 236 based on the captured facial expression 222 and is in an expression latent space, which is a higher-dimensional space than the space of the captured facial expression 222. The identity latent code 232 is generated by an identity encoder 238 based on the captured facial identity 224 and is in an identity latent space, which is a higher-dimensional space than the space of the captured facial identity 224. The identity latent code 232 and the identity encoder 238 can each be, for example, a multilayer perceptron or other neural network that maps the respective input to the respective higher-dimensional latent space. The latent code 242 is used as a modulation input to the actuation network 256.

The actuation network 256 uses an implicit representation in which an implicit function learned by the actuation network 256 maps any coordinate position in the canonical space, represented by a canonical space input point 244) to one or more corresponding canonical actuation values 262 for the coordinate position. The implicit function can be a continuous function that maps the canonical space input point to the canonical actuation values 262. Evaluating the implicit function at a set of canonical space input points 244 distributed across a geometric mesh produces canonical actuation values 262 distributed across the mesh. The canonical actuation values represent a mesh that resembles a shape that would be produced if the captured shape 208 were to be mapped to the canonical space. Each evaluation of the implicit function can be performed by a respective execution of the actuation network 256. Each evaluation of the implicit function can also, or instead, be performed by the same execution of the actuation network 256. That is, one execution of the actuation network 256 can generate the canonical actuation values 262 for one of the canonical space input points 244. An execution of the actuation network 256 (e.g., in a training pass) can also or instead generate the canonical actuation values 262 for two or more of the canonical space input points 244. Since particular canonical space input points 244 are provided to the actuation network 256 as input, the actuation network 256 is independent of a particular resolution of the canonical space input points 244 on the geometric mesh. The implicit function learned by each control network 250 is defined on a continuous canonical space, so that coordinates of any point in the continuous canonical space can be specified. For each canonical space input point 244 provides as input to the actuation network 256, the actuation network 256 generates canonical actuation values 262 that correspond to the specified coordinates of the canonical space input point 244.

Because the actuation network 256 uses the implicit representation, each control network is agnostic to the underlying shape representation. In other words, there is no need to manually re-define the architecture of the actuation network 256 or retrain the actuation network 256 if the underlying representation or resolution changes. These properties render the method generally applicable to arbitrary soft body inputs and reduce the required expert knowledge, allowing artists to generate new poses and animations efficiently.

In accordance with the implicit representation used by the actuation network 256, the control network training engine 122B generates a set of material space input points 250. The material space input point 250 can be in the soft tissue space of the captured shape 208, for example. Each of the material space input points 250 is converted to a respective canonical space input point 244 using a material to canonical space mapping network 252 associated with the captured facial identity 224 that corresponds to the captured shape 208 in the training data 206. In each training pass, the control network training engine 122B invokes the actuation network 256 and/or bone network 258 for each of the canonical space input points 244, and the actuation network 256 and/or bone network 258 generates canonical control values 260 based on the canonical space input point 244 and the latent code 242. The bone network 258 generates canonical bone position values 264 for a jaw bone segment based on the latent code 242. For soft bodies that represent faces, the underlying geometry can be extended with bone structures. Diverse expressions can be articulated by considering the relative motion between the skull (e.g., the face generated by the actuation network 256) and the mandible (e.g., the jaw bone segment generated by the bone network 258). Thus, the skull position is fixed, and mandible kinematics are learned by the bone network 258. Different from the actuation mechanism acting on the inside of the soft tissue, the bone structure is located at the boundary and provides a Dirichlet boundary condition in the physics-based simulation. The Dirichlet condition can represent a joint or pivot point link between the skull and the jaw bone, for example. The position of the bone is determined by the bone network 258, which takes a latent code 242 as input and outputs a set of canonical bone position values 264 that are based on the latent code 242. The canonical bone position values 264 can be a canonical-space transformation matrix. The canonical-space transformation matrix can be applied to points on the bone geometry to transform the jaw bone position.

The control network training engine 122B converts the canonical control values 260 from the canonical space to identity-specific control values 270 in an identity-specific space using the inverse mapper 266. The inverse mapper 266 performs the inverse operation of the material to canonical space mapping network 252. The control network training engine 122B then provides the identity-specific control values 270, which include the identity-specific actuation values 272 and/or the identity-specific bone position values 274, as input to the physics simulator 280. The physics simulator 280 generates the soft body 284 based on the identity-specific control values 270 and one or more collision constraints 282. Collision constraints 282 for a simulated active soft body 284 that represents a human face can specify that the mouth's lips are not to overlap when they collide, for example. The simulated active soft body 284 has the muscle actuations of the captured facial identity 224 performing the captured facial expression 222 as applied to the face represented by the captured shape 208.

In various embodiments, the control networks 254 use a differentiable collision model, which enables the control networks 254 to learn collision-agnostic muscle-driven expression activations without learning collision responses such as skin deformations that occur as a result of surface penetrations or other skin deformations resulting from collisions between facial surfaces. Such collision responses can be present in the training data, but are identity specific and need not be learned by the control networks 254. Using the differentiable collision model, the control networks 254 learn collision-agnostic muscle actuation mechanisms. Accordingly, the control networks 254 do not learn collision responses, such as skin deformations, as part of the actuation mechanism. The control networks 254 retarget the learned collision-agnostic actuation mechanisms to different identities at inference time. The execution engine 124 applies identity-specific collision response during simulation, which occurs subsequent to performance retargeting performed by the control networks 254.

In various embodiments, the simulator framework, which includes the control networks 254 and the physics simulator 280, has three energy terms: shape targeting, bone attachment, and contact energies. The shape targeting and bone attachment terms are based on Projective Dynamics, in which the local constraint can be represented as follows:

$${E}_{i} ( u ) = {min}_{{y}_{i}} \frac{{ω}_{i}}{2} {‖ {G}_{i} {S}_{i} u - {B}_{i} {y}_{i} ‖}_{F}^{2} s . t . {C}_{i} ( {y}_{i} ) = 0 ,$$

where u denotes the simulation vertices, ωᵢ is a weight coefficient, and yᵢ is an auxiliary variable representing the target position. Sᵢ is a selection matrix choosing degrees of freedom (“DOFs”) involved in Eᵢ. Gᵢ and Bᵢ facilitate the distance measure. For the shape targeting energy, Gᵢ maps u to the deformation gradient Fᵢ. Bᵢ is from the input actuation tensor Aᵢ and yᵢ is the given target position. The total energy E(u) is the sum of these local constraints. This type of energy is solved using a local-global scheme. In the local step, the yᵢ are solved for in parallel. In the global step, the following global step linear equation is solved, which is derived by setting ∇E=0:

$$( {\sum }_{i} {ω}_{i} {S}_{i}^{T} {G}_{i}^{T} {G}_{i} {S}_{i} ) u = {\sum }_{i} {ω}_{i} {S}_{i}^{T} {G}_{i}^{T} {B}_{i} {y}_{i} .$$

After converging to a local minimum, sensitivity matrices for the input variables of interest can be calculated with implicit differentiation. For example, the sensitivity matrix of u with respect to Aᵢ is given by:

$$\frac{\partial u}{\partial {A}_{i}} = - {( {∇}^{2} E )}^{- 1} \frac{\partial ∇ E}{\partial {A}_{i}} .$$

For the collision model, the differentiable Incremental Potential Contact (“IPC”) model is used. The IPC model exploits a smoothly clamped barrier potential to penalize collision, as follows:

$${B}_{i} ( {d}_{i} ) = \{ \begin{matrix}- {( {d}_{i} - \hat{d} )}^{2} ln ( \frac{{d}_{i}}{\hat{d}} ) , & 0 < {d}_{i} < \hat{d} \\ 0 , & {d}_{i} \geq \hat{d}\end{matrix}$$

where dᵢ is the unsigned distance between the given pair i of surface primitives, e.g., vertex-triangle or edge-edge, and \hat{d} is a user-defined tolerance of the collision resolution. B(d) applies no repulsion for pairs having dᵢ≥\hat{d}, initiates contact force for dᵢ<\hat{d}, and approaches infinity at zero distance. Consequently, as long as there is a collision-free state at the beginning of the simulation, using such potential forestalls interpenetration afterwards. In various embodiments, this barrier energy is used in the simulator framework that includes the control networks 254 and the physics simulator 280 by solving the following optimization problem:

$${min}_{u} E ( u ) + B ( u ) ,$$

where B(u) is the sum of the barrier potentials for the collision pairs constructed from u. However, B(u) is a nonlinear energy, and is not based on Projective Dynamics. For consistency, B(u) is projected to its local hyper paraboloid centered at û, that is, from the last iteration, using Taylor expansion:

$$\hat{B} ( u ) = B ( \hat{u} ) + ∇ {B ( \hat{u} )}^{T} {( u - \hat{u} )}^{T} + \frac{1}{2} {( u - \hat{u} )}^{T} {∇}^{2} B ( \hat{u} ) ( u - \hat{u} ) .$$

After projection, ∇\hat{B}=0 is added into the global step linear equation shown above, giving the following linear system:

$$( {∇}^{2} B + \underbrace{{\sum }_{i} {ω}_{i} {S}_{i}^{T} {G}_{i}^{T} {G}_{i} {S}_{i}}_{K} ) u = {∇}^{2} B \hat{u} - ∇ B + {\sum }_{i} {ω}_{i} {S}_{i}^{T} {G}_{i}^{T} {B}_{i} \cdot {y}_{i} ,$$

where the explicit evaluation of ∇B and ∇²B is removed for simplicity. The calculation of the sensitivity matrix is adapted similarly. For example, the sensitivity matrix of u with respect to Aᵢ is given by:

$$\frac{\partial u}{\partial {A}_{i}} = - {( {∇}^{2} E + {∇}^{2} B )}^{- 1} \frac{\partial {∇}_{u} E}{\partial {A}_{i}} .$$

The construction of the Hessians on the right side of the above equation is described in U.S. patent application Ser. No. 18/159,651, filed Jan. 25, 2023, which is incorporated herein by reference. In the linear system equation above, K is a Laplacian-style positive definite symmetric matrix that remains fixed throughout the simulation. The quantity ∇²B changes, but affects a relatively small portion of the left-hand side of the linear system equation. To maintain positive definiteness of the linear system, ∇²B is projected to the cone of positive semidefinite matrices, as in the IPC model. The linear system can then be efficiently solved using the preconditioned conjugate gradient method, with pre-factorized K serving as the preconditioner. In addition, continuous collision detection is used to ensure that the linear system remains penetration-free at each iteration, and line search is used to achieve convergency when needed. To improve the performance, the collision-prone regions (e.g., the lips) can be marked out on the embedded facial surface, and only those regions can be considered when constructing B.

In various embodiments, the physics simulator 280 receives the identity-specific bone position values 274 as input. The identity-specific bone position values 274 can represent the position of a jaw bone relative to a skull to which the jaw bone is pivotally attached, for example. The identity-specific bone position values 274 can specify that the simulated active soft body 284 is to move the jaw bone of a simulated face soft body downward, thereby causing the mouth portion of the face to open, for example.

The training engine 122 trains the control networks 254 using gradient descent with back propagation of a gradient to the networks. Thus, training engine 122 computes the gradient of the actuation network 256 and/or the bone network 258 with respect to the vertices of an actuated geometric mesh of the simulated active soft body 284.

Upon updating the control networks 254 based on the facial geometry loss 286, the training engine 122 has completed a training pass. The training engine 122 then determines whether a threshold condition is satisfied, e.g., whether facial geometry loss 286 falls below a threshold and/or until a threshold number of passes have been performed. If the threshold condition is not satisfied, the training engine 122 continues by performing another pass until the threshold condition is satisfied.

While the operation of training engine 122 has been described above with respect to certain types of losses, it will be appreciated that the material to canonical space mapping networks 212, actuation network 256, and/or bone network 258 can be trained using other types of techniques, losses, and/or machine learning components. For example, training engine 122 could train the material to canonical space mapping networks 212, actuation network 256, and/or bone network 258 in an adversarial fashion with one or more discriminator neural networks (not shown) using one or more discriminator losses that are computed based on predictions generated by the discriminator neural network(s) from captured shape 208 and simulated active soft body 284.

The actuation mechanism can be controlled by artists or animators to perform simulation operations such as shape targeting or other animation tasks. Constraints and external force vectors can also be specified as input to the physics simulator 280 to control the internal actuation mechanism and thereby deform the shape of the simulated active soft body 284. Thus, a user such as an animator can animate the simulated active soft body 284 by providing commands to the physics simulator 280. For example, a user can provide a command that specifies an external force vector to cause the soft body 284 to deform in response to the force vector in accordance with the canonical control values 260, simulated laws of physics, and/or collision constraints 282.

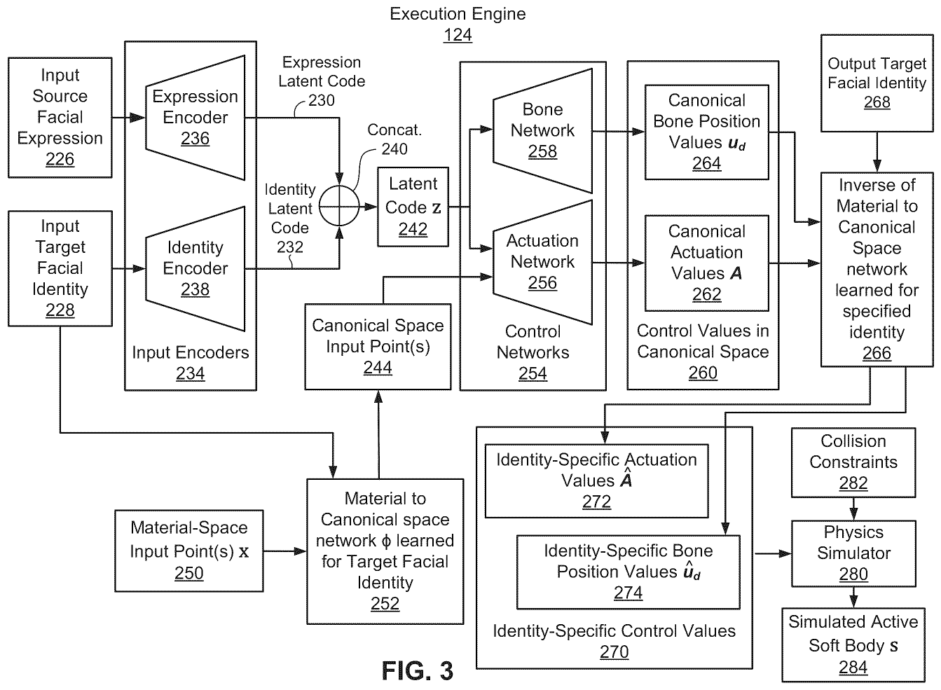

FIG. 3 is a more detailed illustration of the execution engine of FIG. 1, according to various embodiments. More specifically, FIG. 3 illustrates the operation of the execution engine 124 in using the material to canonical space mapping networks 252 and control networks 254 trained by the mapping training engine(s) 122. The execution engine 124 uses the material to canonical space mapping network 252 and the control networks 254 to generate identity-specific control values 270 based on a given input source facial expression 226, a given input target facial identity 228, and a given output target facial identity 268. The physics simulator 280 then uses the identity-specific control values 270 to generate a simulated active soft body 284 that represents the muscle actuations of the identity specified by the input target facial identity 228 performing the expression specified by the input source facial expression 226 as applied to the face of an identity specified by the output target facial identity 268. The output target facial identity 268 can be the same as the input target facial identity 228, or can be an identity of a different character on which the control networks 254 have been trained. The output target facial identity 268 can thus be an optional input to the execution engine 124. If the output target facial identity 268 is not specified as an input to the execution engine 124, then the output target facial identity 268 is the same as the input target facial identity 228.

The execution engine 124 converts the input source facial expression 226 to the expression latent code 230 using the expression encoder 236, and converts the input target facial identity 228 to the identity latent code 232 using the identity encoder 238. The execution engine 124 uses a material to canonical space mapping network 252 associated with the input target facial identity 228 to convert each material space input point 250 to a respective canonical space input point 244. Each material space input point 250 can be in a soft tissue space of a specified face. The control networks 254 generate the canonical control values 260 based on the canonical space input point 244 and the latent code 242 as described herein with respect to FIG. 2B. Each canonical control value 260 specifies a deformation of a canonical geometric mesh in the canonical space. The inverse mapping 266 converts the canonical control values 260 to identity-specific control values 270 in an identity-specific space of a target facial identity. The target facial identity can be specified by the output target facial identity 268. If the output target facial identity 268 is not specified, then the input target facial identity 228 can be used as the target facial identity that provides the identity-specific space for the output of the inverse mapping 266

In various embodiments, the physics simulator 280 converts the identity-specific control values 270 to an actuated simulation mesh (not shown). The execution engine 124 converts the actuated simulation mesh to the soft body 284 and outputs the soft body 284. For example, the simulated active soft body 284 can be outputted on a display of computer system 100 and subsequently distorted in response to further control input provided to the physics simulator 280, e.g., by an artist or animator. The further control input can include additional constraints and external forces. For example, collision constraints 282 for a simulated active soft body 284 that represents a human face can specify that the mouth's lips are not to overlap when they collide. As another example, an external force vector can cause the simulated active soft body 284 to deform in accordance with the direction and magnitude of the force vector.

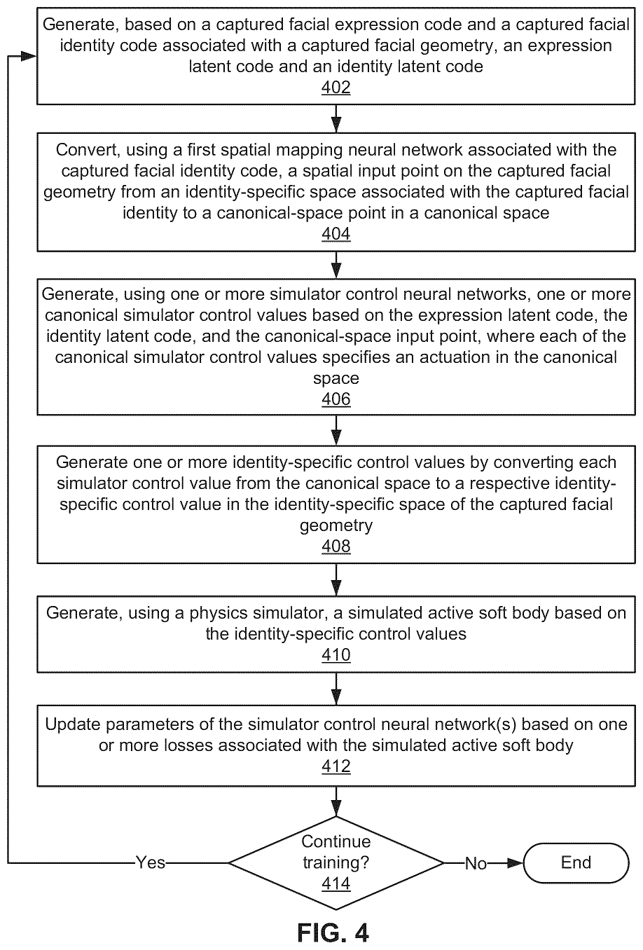

FIG. 4 is a flow diagram of method steps for training one or more machine learning models to perform facial animation retargeting, according to various embodiments. Although the method steps are described in conjunction with the systems of FIGS. 1-3, persons skilled in the art will understand that any system configured to perform the method steps in any order falls within the scope of the present disclosure.

As shown, in step 402, a training engine 122 generates, based on a captured facial expression 222 and a captured facial identity 224 associated with a captured shape 208 that represents a face, an expression latent code 230 and an identity latent code 232. In operation 404, the training engine 122 converts, using a first spatial mapping neural network 252 associated with the captured facial identity 224, a spatial input point 250 on the captured shape 208 from an identity-specific space associated with the captured facial identity 224 to a canonical-space input point 244 in a canonical space.

In operation 406, the training engine 122 generates, using one or more simulator control neural networks 254, one or more canonical simulator control values 260 based on the expression latent code 230, the identity latent code 232, and the canonical-space input point 244. The canonical simulator control values 260 specify actuations in the canonical space. The actuations represent deformations in the canonical space. The canonical actuations are to be converted to identity-specific actuations. In various embodiments, the training engine 122 generates a latent code 242 based on the expression latent code 230 and the identity latent code 232, and then uses the control networks 254 to generate the canonical control values 260 based on the latent code 242 and the canonical space input point 244.

In operation 408, the training engine 122 generates one or more identity-specific control values 270, e.g., actuations in an identity-specific space, by converting each canonical simulator control value from the canonical space to a respective identity-specific control value in the identity-specific space of the captured facial geometry. In operation 410, the training engine 122 generates, using a physics simulator 280, a simulated active soft body based on the identity-specific control values and a target simulation mesh (not shown). The target simulation mesh can be associated with the captured facial identity 224 and can be generated for the captured facial identity 224 as described herein with reference to FIG. 2A. The target simulation mesh is a volumetric mesh used by the physics simulator 280. The target simulation mesh can be a hexahedral mesh having hexahedral mesh elements, for example. A geometric surface mesh (not shown) is embedded inside the simulation mesh (e.g., using trilinear interpolation for hexahedral mesh elements). The geometric surface mesh embedded in the simulation mesh can be a triangle mesh of triangular mesh elements, for example, and can be used for calculating the facial geometry loss 286.

In operation 412, the training engine 122 updates parameters of the simulator control neural network(s) 254 based on one or more losses associated with the simulated active soft body 284. The losses can include a facial geometry loss 286 and/or a mapping loss 220. The training engine 122 can train the control networks 254 and/or the material to canonical space mapping networks 212 by computing the simulation loss 286 between the captured shape 208 and the soft body 230. The captured shape 208 is thus used as a ground truth target shape by the training engine 122. The vertices in the geometric surface mesh embedded in the simulation mesh of a simulated active soft body 284 produced by the physics simulator 280 correspond to vertices in a geometric surface mesh included in a captured shape 208 that corresponds to the simulated active soft body 284. The simulated active soft body 284 and the captured shape 208 can correspond to the same identity, for example. The facial geometry loss 286 can be determined by computing the distance between each vertex in the geometric surface mesh embedded in the simulation mesh of the simulated active soft body 284 and the corresponding vertex in the geometric surface mesh of the captured shape 208.

The simulation loss 286 can include (but is not limited to) the loss between vertices of the simulated active soft body 284 and vertices of the captured shape 208 and/or a loss between normals of the vertices of the simulated active soft body 284 and normals of the vertices of the captured shape 208, or another measure of error between the captured shape 208 and the simulated active soft body 284. The loss function can be, for example:

$${ℒ}_{g e o} = ‖ s - {s}_{captured} ‖ + ‖ 1 - n \cdot {n}_{captured} ‖ ,$$

where s corresponds to the vertices of the simulated active soft body 284, s_{captured} corresponds to the vertices of the captured shape 208, n corresponds to the normals of the vertices of s, and n_{captured} corresponds to the normals of the vertices of s_{captured}. The loss function can include additional terms, such as a term that regularizes the actuation mechanism to be as little actuated as possible (e.g., based on a difference between each actuation matrix and the identity matrix, and/or a term that enforces smoothness by constraining the Lipschitz constant of the network to be small). A sensitivity matrix such as that described herein with respect to FIG. 2B can be used by the training engine 122 to minimize the loss function. The sensitivity matrix can be provided as an input to a machine learning framework such as PyTorch™ or the like.

The training engine 122 can use gradient descent and backpropagation to update neural network weights or other parameters of the control networks 254 and/or the material to canonical space mapping networks 212 in a way that reduces the measure of error. For example, the training engine 122 can calculate the gradient accumulated on the vertices of the soft body 230 and back propagate the gradient to the control networks 254. The back propagation to the control networks 254 updates parameters of the control networks 254.

The training engine 122 trains the actuation network 256 and/or the bone network 258 based on the facial geometry loss 286 as described above with respect to FIG. 2A by propagating the gradient accumulated on the vertices of the actuated simulation mesh of the simulated active soft body 284 to the identity-specific control values 270 and then to the canonical control values 260. The gradient accumulated on the vertices can be propagated to the identity-specific control values 270 by multiplying the gradient accumulated on the vertices by a sensitivity matrix. The resulting gradient accumulated on the identity-specific control values 270 can then be propagated to the canonical control values 260 using the material to canonical space mapping network 252. The training engine 122 can then use gradient descent based on the gradient accumulated on the canonical control values 260 and backpropagation to update neural network weights in the actuation network 212 in a way that reduces the measure of error.

In operation 414, the training engine 122 determines whether or not training of the actuation network 256 and/or the bone network 258 is to continue. For example, the training engine 122 can determine that the actuation network 256 and the bone network 258 should continue to be trained using a simulation loss until one or more conditions are met. These condition(s) include (but are not limited to) convergence in the parameters of the actuation network 256 and/or the bone network 258, lowering of the facial geometry loss 286 and/or the mapping loss 220 to below a threshold, and/or a certain number of training steps, iterations, batches, and/or epochs. While training of the actuation network 256 and/or the bone network 258 continues, the training engine 122 repeats steps 402 through 412. The training engine 122 then ends the process of training the actuation network 256 and/or the bone network 258 once the condition(s) are met.

The training engine 122 could also, or instead, perform one or more rounds of end-to-end training of the material to canonical space mapping network 252 for a particular captured facial identity 224, the actuation network 256, and the bone network 258 to optimize the operation of all networks to the task of generating canonical control values 260 that, when converted to identity-specific control values 270, cause a physics simulator 280 to produce a simulated active soft body 284 having the specified captured facial expression 222 and captured facial identity 224 as applied to the captured shape 208.

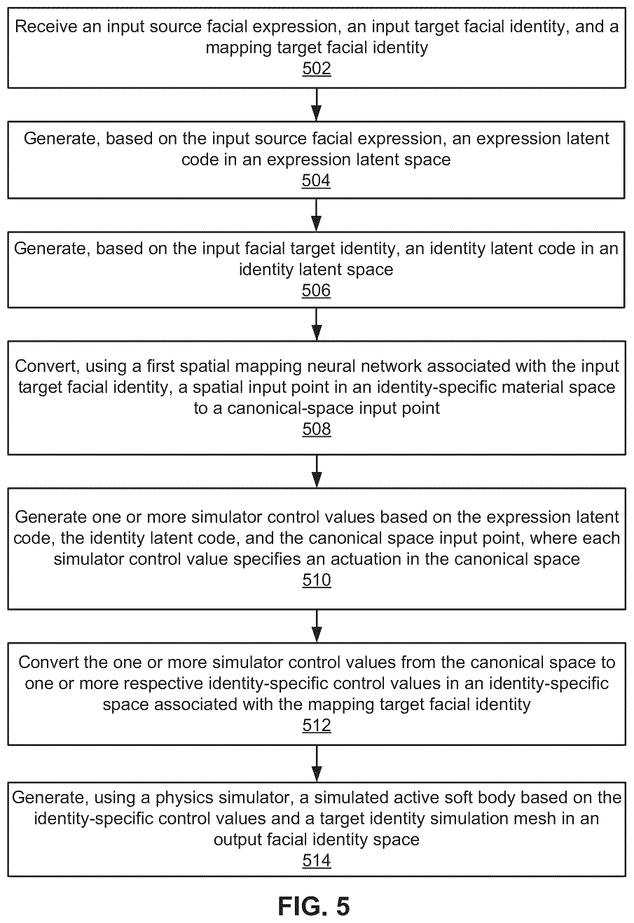

FIG. 5 is a flow diagram of method steps for facial animation retargeting, according to various embodiments. Although the method steps are described in conjunction with the systems of FIGS. 1-3, persons skilled in the art will understand that any system configured to perform the method steps in any order falls within the scope of the present disclosure.

As shown, in operation 502, an execution engine 124 receives an input source facial expression 226, an input target facial identity 228, and a output target facial identity 268. In operation 504, the execution engine 124 generates, based on the input source facial expression 226, an expression latent code 230 in an expression latent space. The output target facial identity 268 can be the same as the input target facial identity 228, or an identity of a different character on which the control networks 254 have been trained. The input source facial expression 226 and the input target facial identity 228 are further described herein with respect to FIG. 2B. The mapping target facial identity 268 is further described herein with respect to FIG. 3.

In operation 506, the execution engine 124 generates, based on the input target facial identity 228, an identity latent code 232 in an identity latent space. In operation 508, the execution engine 124 converts, using a first spatial mapping neural network 252 associated with the input target facial identity 228, a spatial input point 250 in an identity-specific material space to a canonical-space input point 244 in a canonical space. The execution engine 124 identifies the spatial input point 250 in the identity-specific material space according to a predetermined or specified resolution, e.g., such that a predetermined number of spatial input points 250 distributed across the simulation mesh are identified. The execution engine 124 converts each identified spatial input point 250 to a canonical space input point 244 and executes the control network(s) 254 for each canonical space input 244, using the canonical space input point 244 and the latent code 242 as input to the control network(s) 254.

In operation 510, the execution engine 124 generates one or more canonical control values 260 for a physics simulator 280 based on the expression latent code 230, the identity latent code 232, and the canonical-space input point 244. The canonical control values 260 specify actuations in the canonical space. In various embodiments, the execution engine 124 generates a latent code 242 based on the expression latent code 230 and the identity latent code 232, and then uses the control networks 254 to generate the canonical control values 260 based on the latent code 242 and the canonical space input point 244.

In operation 512, the execution engine 124 converts the canonical control values 260 from the canonical space to one or more respective identity-specific control values 270, which are in an identity-specific space associated with the mapping target facial identity 268. In operation 514, the execution engine 124 generates, using a physics simulator 280, a simulated active soft body 284 based on the identity-specific control values 270 and a target identity simulation mesh (not shown) in an output facial identity space. The output facial identity space can be the identity-specific space of the mapping target facial identity 268 or the identity-specific space of the input target facial identity 228. For example, if the mapping target facial identity 268 is not specified, then the output facial identity space can be the identity-specific space of the input target facial identity 228.

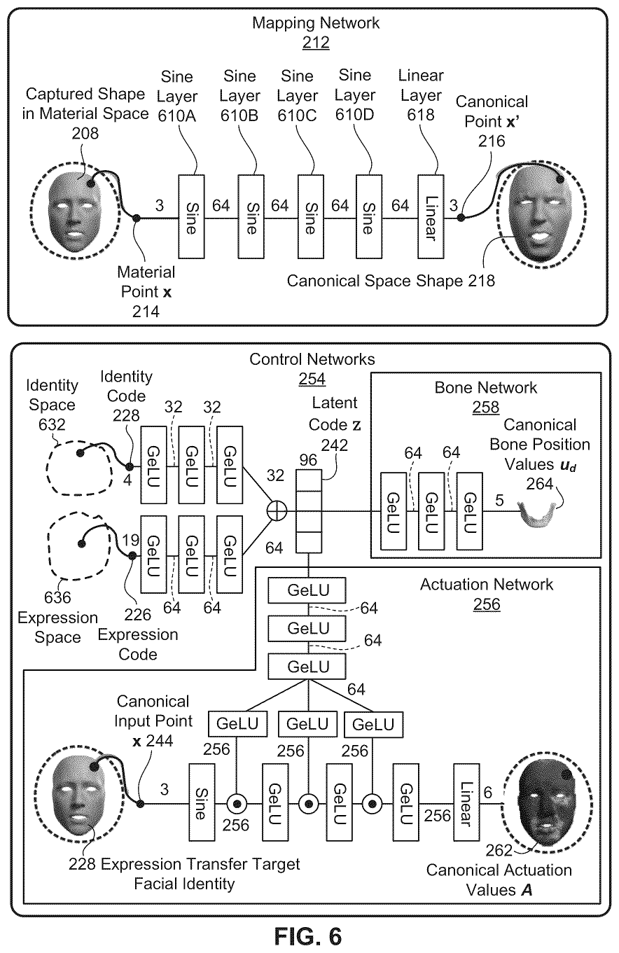

FIG. 6 illustrates neural networks that perform facial animation retargeting, according to various embodiments. The neural networks include a material to canonical space mapping network 212 (“ϕ”), which maps a material point 214 (“x”) on a captured shape 208 in an identity-specific space of the captured shape 208 to a canonical point 216 (“x”) on a canonical space shape 218 in a canonical space. In one example. the material to canonical space mapping network 212 has four sine layers 610, including sine layer 610A, sine layer 610B, sine layer 610C, and sine layer 610D and one linear layer linear layer 618. Each sine layer 610 can be a SIREN layer, for example, and can have a frequency hyperparameter ω0 such with a value such as 5. A material to canonical space mapping network 212 is trained for each identity in examples described herein. In other examples, a material to canonical space mapping networks 212 can be trained for multiple identities. The input to the first sine layer 610A is the material point 214 (“x”) having dimension 3 (e.g., x, y, and z coordinates). The output of the sine layer 610A and each of the subsequent sine layers 610B, 610C, 610 is of dimension 64. The linear layer 618 receives the output of the sine layer 610D and produces a canonical point 216 (“x”) of dimension 3. Although particular neural network layers and specific dimensions are described in the examples of FIG. 6, any suitable neural network layers and any suitable dimensions can be used in other examples.

The control networks 254 include an identity-encoding network, e.g., an MLP, which is trained to map an input target facial identity 228 (of dimension 4) from an identity space 632 to an identity latent code 232 (of dimension 32) using three fully connected layers, which are shown as Gaussian Error Linear Unit (“GeLU”) layers in the example of FIG. 6. The output of each GeLU layer between the identity point 634 and the latent code 242 is of dimension 32. The control networks 254 also include an expression-encoding network, e.g., another MLP, that is trained to map an input source facial expression 226 (of dimension 19) from an expression space 636 to an expression latent code 230 (of dimension 64). The output of each GeLU layer between the expression point 638 and the latent code 242 is of dimension 64. A concatenation operation concatenates the 32-dimensional output of the identity-encoding network with the 64-dimensional output of the expression-encoding network to produce a 96-dimensional latent code 242 (“z”).

A bone network 258 receives the latent code 242 (“z”) and generates one or more canonical bone position values 264. Jaw bone motion is linked to the skull via a pivot point, represented as a joint with two degrees of freedom for rotation and three for translation, specified canonical bone position values 264, which are also referred to herein as transformation parameters. The transformation parameters include θx, θy and a three-dimensional translation tx, ty, tz. The transformation parameters, specified as a 5-dimensional vector, {θx, θy, tx, ty, tz}ϵR⁵, are the output of the bone network 258. The transformation parameters are subsequently converted into a transformation matrix. The bone network 258 includes three fully connected (e.g., GeLU) layers that map a 96-dimensional latent code 242 to the 5-dimensional vector of parameters used to construct the transformation matrix. The transformation matrix is combined with each point x on a jaw bone using matrix-vector multiplication of the transformation matrix by each point x. The results of the multiplication, which specify the transformed jaw bone position, are output by the bone position network 218 as canonical bone position values u_{d} 264

An actuation network 256 is trained to generate canonical actuation values 262 based on a latent code 242 and canonical space input point 244. The latent code 242 is a modulation input to the actuation network 256. The actuation network 256 has a backbone that includes a sinusoidal layer followed by three consecutive GeLU layers and a linear layer. The sinusoidal layer learns a positional encoding. Since the GeLU activation function is unbounded from above, the tanh activation function is used to bound the modulation input. The latent code 242 is processed by three consecutive GeLU layers, each having a 64-dimensional vector as output. The output of the third consecutive GeLU layer is provided as input to a further three GeLU layers, each of which transforms the 64-dimensional vector to a 256-dimensional vector. One of the three 256-dimensional vectors is with the output of the sinusoidal layer to form a 256-dimensional input to the first GeLU layer of the backbone. The other two 256-dimensonal vectors are combined with the output of the second and third GeLU layers, respectively, to form a 256-dimensonal input to each subsequent GeLU layer. The third GeLU layer of the backbone provides a 256-dimensional vector to a linear layer, which maps the 256-dimensioal vector to a 6-dimensional vector that is sued as the canonical actuation values 262 (“A”).

In sum, the disclosed performance retargeting system retargets a given facial expression of a source character to a target character having a target facial identity. The resulting new character has the specified target facial identity with the facial expression of the source character. The target character is generated using a physics-based simulation in which simulation elements, which represent facial muscles, are controlled by element actuation control values. Thus, the new character is represented by a simulated three-dimensional soft body in which the facial muscles of the target facial identity are actuated, e.g., contracted or relaxed, to produce the source expression.

In operation, an actuation neural network (“actuation network”) predicts the actuation control values (“actuations”) for input spatial points on a geometric mesh that represents a face. The actuation uses an implicit representation in which a learned implicit function maps any specified point on a simulation mesh in a specified resolution to corresponding control values for the point. The actuation network is trained on performance training data of multiple captured characters to enable the network to perform facial animation retargeting by changing the performance (e.g., expression) of a target character while maintaining the identity of the target character. The facial geometries of the captured characters in the training data have different material spaces, which have different geometric meshes with different numbers and layouts of volumetric elements. The performance retargeting system transforms the captured characters to the unified canonical space using a learned mapping network to enable the actuation network to be trained on multiple identities and also to learn cross-identity physical correlations. The transformation to the canonical space is performed by a material-to-canonical space mapping neural network.

The actuation network is executed for a set of input spatial points, which can be distributed across the surface of a simulation mesh. The input to the actuation network includes an input spatial point and a latent-space code that represents the desired facial expression and desired facial identity. Each execution of the actuation network generates one or more actuations for a specified input spatial point in canonical space based on the desired facial expression and facial identity represented by the latent-space code. Each input spatial point in canonical space is generated by converting a material space input point, e.g., in a soft tissue space of a specified face, to a canonical space point in the canonical space. The conversion can be performed by the mapping network.

The facial retargeting system converts the actuations generated by the actuation network from canonical space to identity-specific actuations in an identity-specific space of a particular identity using an inverse mapping associated with the particular identity. The identity-specific actuations are suitable for input to a physics simulator and cause a physics-based simulator to deform a simulation mesh associated with the particular identity. For example, the particular identity can be the desired facial identity, in which case the canonical-space actuations are converted from canonical space to actuations specific to the desired facial identity using an inverse mapping function associated with the desired facial identity. Alternatively, the particular identity can be different from the desired facial identity, in which case the canonical-space actuations are converted from canonical space to actuations specific to the specified identity using an inverse mapping function associated with the specified identity. The identity-specific actuations are provided as input to the physics simulator, which produces a simulated active soft body that represents the new character that has the specified target facial identity with the facial expression of the source character. Collision constraints can also be provided as input to the physics simulator, which identifies effects such as lip contact, collision with internal teeth and bone structures, or other physical effects that allow artist control over the retargeted performance. The collision constraints are applied in the simulator using a contact model to correct penetrations that occur as a result of collisions between facial regions.

One technical advantage of the disclosed techniques relative to the prior art is that training the actuation network on multiple characters in the canonical space reduces the amount of training data needed for each character. Another technical advantage of the disclosed techniques is that coordinated data is not needed across characters. The training performances can be different from character to character, but since the actuation network is trained on multiple characters in a single shared canonical space, the network can learn character-specific activations across the training dataset. Training the actuation network on multiple characters enables the actuation network to interpolate across the identity-expression space and generalize to target identities that were not seen during training and also to source expressions that were not seen during training.

Another technical advantage of the disclosed techniques is that the resulting retargeted animation is collision-free, and the actuation network need not learn to handle collisions. Existing techniques implement collision handling in the training of a neural network, which causes the network to predict actuations that model collisions in addition to other effects not related to collision, which can complicate the model and detract from the learning of the other effects. In the disclosed technique, collision handling is performed using a contact model in the simulator that generates the resulting retargeted animation based on the predicted actuations, so the actuation network learns muscle-driven expression activations but does not learn collisions. Thus, in the disclosed technique, the actuation model does not attempt to model collisions in addition to the mapping of the latent code to actuations, so the actuation model can focus on learning to predict actuations.

Still another technical advantage of the disclosed techniques is that the implicit function technique enables the neural network to be substantially smaller in size relative to neural networks used in existing techniques, while reliably reproducing fine details such as wrinkles. These technical advantages provide one or more technological improvements over prior art approaches.
1. In some embodiments, a computer-implemented method comprises generating, based on an input target facial identity, a facial identity code in an input identity latent space, converting a spatial input point from an input facial identity space of the input target facial identity to a canonical-space point in a canonical space, generating one or more canonical simulator control values based on the facial identity code, an input source facial expression, and the canonical-space point, and generating a simulated active soft body based on one or more identity-specific control values, wherein each identity-specific control value corresponds to one or more of the canonical simulator control values and is in an output facial identity space associated with an output target facial identity.
2. The computer-implemented method of clause 1, wherein the spatial input point is converted to the canonical-space point via execution of a material space to canonical space mapping network associated with the input target facial identity.
3. The computer-implemented method of clauses 1 or 2, further comprising generating, based on the input source facial expression, a facial expression code in an expression latent space, wherein the one or more canonical simulator control values are generated further based on the facial expression code.
4. The computer-implemented method of any of clauses 1-3, wherein the expression latent space and the identity latent space are latent control spaces of the physics simulator used to generate the simulated active soft body.
5. The computer-implemented method of any of clauses 1-4, further comprising converting the one or more canonical simulator control values from the canonical space to the one or more identity specific control values in the output facial identity space.
6. The computer-implemented method of any of clauses 1-5, wherein converting the one or more canonical simulator control values from the canonical space to the one or more identity specific control values in the output facial identity space comprises identifying a material space to canonical space mapping network associated with the input target facial identity, and multiplying the one or more canonical simulator control values by a rotational component of a Jacobian of the material space to canonical space mapping network.
7. The computer-implemented method of any of clauses 1-6, wherein each identity-specific control value specifies an actuation that represents a deformation of the simulated active soft body.
8. The computer-implemented method of any of clauses 1-7, wherein the output target facial identity is the input target facial identity, and the output facial identity space is the input facial identity space.
9. The computer-implemented method of any of clauses 1-8, wherein the output target facial identity is different from the input target facial identity and is received as an input value.
10. The computer-implemented method of any of clauses 1-9, wherein the simulated soft body is generated using a physics simulator based on the one or more identity-specific control values and further based on one or more collision constraints.
11. The computer-implemented method of any of clauses 1-10, wherein the one or more canonical simulator control values are generated via execution of an actuation neural network that receives a latent code and the canonical-space point as input, wherein the latent code is based on the expression latent code and the identity latent code.
12. The computer-implemented method of any of clauses 1-11, further comprising training the actuation neural network based on one or more losses associated with the simulated active soft body.
13. The computer-implemented method of any of clauses 1-12, wherein the one or more losses comprise a similarity loss that is computed based on the simulated active soft body and a captured shape associated with the input target facial identity.
14. The computer-implemented method of any of clauses 1-13, wherein the canonical-space point is one of a plurality of canonical-space points, and generating the one or more canonical simulator control values is repeated for each of the plurality of canonical-space points.
15. The computer-implemented method of any of clauses 1-14, wherein the one or more canonical simulator control values comprise one or more canonical actuation values generated by executing the actuation network for each canonical-space point in the plurality of canonical-space points.
16. The computer-implemented method of any of clauses 1-15, wherein the input facial identity space of the input target facial identity is a soft tissue space of the target identity.
17. The computer-implemented method of any of clauses 1-16, wherein a shape of the simulated active soft body is determined in accordance with the one or more identity-specific control values.
17. The computer-implemented method of any of clauses 1-17, wherein the simulated active soft body has a facial expression that is semantically equivalent to the input source facial expression.
19. In some embodiments, one or more non-transitory computer-readable media store instructions that, when executed by one or more processors, cause the one or more processors to perform the steps of generating, based on an input target facial identity, a facial identity code in an input identity latent space, converting a spatial input point from an input facial identity space of the input target facial identity to a canonical-space point in a canonical space, generating one or more canonical simulator control values based on the facial identity code, an input source facial expression, and the canonical-space point, and generating a simulated active soft body based on one or more identity-specific control values, wherein each identity-specific control value corresponds to one or more of the canonical simulator control values and is in an output facial identity space associated with an output target facial identity.
20. In some embodiments, a system comprises one or more memories that store instructions, and one or more processors that are coupled to the one or more memories and, when executing the instructions, are configured to perform the steps of generating, based on an input target facial identity, a facial identity code in an input identity latent space, converting a spatial input point from an input facial identity space of the input target facial identity to a canonical-space point in a canonical space, generating one or more canonical simulator control values based on the facial identity code, an input source facial expression, and the canonical-space point, and generating a simulated active soft body based on one or more identity-specific control values, wherein each identity-specific control value corresponds to one or more of the canonical simulator control values and is in an output facial identity space associated with an output target facial identity.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method comprising:
generating, based on an input target facial identity, a facial identity code in an input identity latent space;
converting a spatial input point from an input facial identity space of the input target facial identity to a canonical-space point in a canonical space;
generating one or more canonical simulator control values based on the facial identity code, an input source facial expression, and the canonical-space point; and
generating a simulated active soft body based on one or more identity-specific control values, wherein each identity-specific control value corresponds to one or more of the canonical simulator control values and is in an output facial identity space associated with an output target facial identity.

2. The computer-implemented method of claim 1, wherein the spatial input point is converted to the canonical-space point via execution of a material space to canonical space mapping network associated with the input target facial identity.

3. The computer-implemented method of claim 1, further comprising:
generating, based on the input source facial expression, a facial expression code in an expression latent space, wherein the one or more canonical simulator control values are generated further based on the facial expression code.

4. The computer-implemented method of claim 3, wherein the expression latent space and the identity latent space are latent control spaces of the physics simulator used to generate the simulated active soft body.

5. The computer-implemented method of claim 1, further comprising converting the one or more canonical simulator control values from the canonical space to the one or more identity specific control values in the output facial identity space.

6. The computer-implemented method of claim 5, wherein converting the one or more canonical simulator control values from the canonical space to the one or more identity specific control values in the output facial identity space comprises:
identifying a material space to canonical space mapping network associated with the input target facial identity; and
multiplying the one or more canonical simulator control values by a rotational component of a Jacobian of the material space to canonical space mapping network.

7. The computer-implemented method of claim 1, wherein each identity-specific control value specifies an actuation that represents a deformation of the simulated active soft body.

8. The computer-implemented method of claim 1, wherein the output target facial identity is the input target facial identity, and the output facial identity space is the input facial identity space.

9. The computer-implemented method of claim 1, wherein the output target facial identity is different from the input target facial identity and is received as an input value.

10. The computer-implemented method of claim 1, wherein the simulated soft body is generated using a physics simulator based on the one or more identity-specific control values and further based on one or more collision constraints.

11. The computer-implemented method of claim 1, wherein the one or more canonical simulator control values are generated via execution of an actuation neural network that receives a latent code and the canonical-space point as input, wherein the latent code is based on the expression latent code and the identity latent code.

12. The computer-implemented method of claim 11, further comprising training the actuation neural network based on one or more losses associated with the simulated active soft body.

13. The computer-implemented method of claim 12, wherein the one or more losses comprise a similarity loss that is computed based on the simulated active soft body and a captured shape associated with the input target facial identity.

14. The computer-implemented method of claim 1, wherein the canonical-space point is one of a plurality of canonical-space points, and generating the one or more canonical simulator control values is repeated for each of the plurality of canonical-space points.

15. The computer-implemented method of claim 14, wherein the one or more canonical simulator control values comprise one or more canonical actuation values generated by executing the actuation network for each canonical-space point in the plurality of canonical-space points.

16. The computer-implemented method of claim 1, wherein the input facial identity space of the input target facial identity is a soft tissue space of the target identity.

17. The computer-implemented method of claim 1, wherein a shape of the simulated active soft body is determined in accordance with the one or more identity-specific control values.

18. The computer-implemented method of claim 1, wherein the simulated active soft body has a facial expression that is semantically equivalent to the input source facial expression.

19. One or more non-transitory computer-readable media storing instructions that, when executed by one or more processors, cause the one or more processors to perform the steps of:
generating, based on an input target facial identity, a facial identity code in an input identity latent space;
converting a spatial input point from an input facial identity space of the input target facial identity to a canonical-space point in a canonical space;
generating one or more canonical simulator control values based on the facial identity code, an input source facial expression, and the canonical-space point; and
generating a simulated active soft body based on one or more identity-specific control values, wherein each identity-specific control value corresponds to one or more of the canonical simulator control values and is in an output facial identity space associated with an output target facial identity.

20. A system, comprising:
one or more memories that store instructions, and
one or more processors that are coupled to the one or more memories and, when executing the instructions, are configured to perform the steps of:
generating, based on an input target facial identity, a facial identity code in an input identity latent space;
converting a spatial input point from an input facial identity space of the input target facial identity to a canonical-space point in a canonical space;
generating one or more canonical simulator control values based on the facial identity code, an input source facial expression, and the canonical-space point; and
generating a simulated active soft body based on one or more identity-specific control values, wherein each identity-specific control value corresponds to one or more of the canonical simulator control values and is in an output facial identity space associated with an output target facial identity.
